(19) United States
(12) Patent Application Publication
(10) Pub. No.: US 2025/0280471 A1
(43) Pub. Date: Sep. 4, 2025

(54) HEATED WINDSHIELD CONTROL ASSEMBLY

(71) Applicant: J.B. Poindexter & Company, Houston, TX (US)

(72) Inventors: Adam Klauer, Ann Arbor, MI (US); Gregory Weber, Commerce Twp., MI (US)

(21) Appl. No.: 19/067,881

(22) Filed: Mar. 1, 2025

Related U.S. Application Data
(60) Provisional application No. 63/561,291, filed on Mar. 4, 2024.

(51) Int. Cl. H05B 3/86; G05D 23/24; H05B 1/02

(52) U.S. Cl. CPC H05B 3/86; G05D 23/2401; H05B 1/0236

(57) ABSTRACT

A glass panel assembly for use in a vehicle having a power source. The assembly includes at least one transparent panel and a defroster assembly. The defroster assembly has a conductive medium disposed adjacent the inner surface of one transparent panel and a controller that is operably connected to both the conductive medium and the power source. The controller determines the resistance of the conductive medium and based on said determination, the controller determines a corresponding temperature of the outer surface of the transparent panel. Based on the determined corresponding temperature of the outer surface of the transparent panel, the controller controls a duty cycle that drives the conductive medium to heat the at least one transparent panel. Optionally, the conductive medium can be eGlass.

### CROSS-REFERENCE TO RELATED APPLICATIONS

This application claims priority to and the benefit of the filing date of U.S. Provisional Patent Application No. 63/561,291, filed Mar. 4, 2024, the entirety of which is incorporated by reference herein.

### FIELD

This disclosure is generally related to windshields of vehicles and, more particularly, to devices and methods of use thereof for defogging and/or defrosting a windshield of a vehicle.

### BACKGROUND

Various devices and methods of use thereof are known for either preventing and/or removing fog and/or frost from the windshield of a vehicle. These devices and methods play a vital role in the safe operation of the corresponding vehicles in that they help ensure that the operator of the vehicle has an unimpeded view of persons, other vehicles, etc., in the path of the vehicle. One known method for removing fog and/or frost from the windshield of a vehicle includes heating the windshield by means of passing current through conductive traces, films, wires, eGlass (commonly referred to as wiggle wire), and the like that are disposed between optically transparent panels of glass of the windshield. For example, these traces or films may be embedded in an intermediate polymeric-based material between the panels. Although such devices are often effective, they have the potential to unnecessarily waste energy in that they typically require the operator of the vehicle to turn them off after the fog/frost has been removed from the windshield. Other than a possible light to indicate energy is being provided to the defogging/defrosting device, the operator has no indication that energy is being needlessly provided once the fog/frost is gone. Of course, unnecessary energy usage is of concern in electronically powered vehicles in that time of operation, range, etc., are adversely affected. Unnecessarily operating the defogging/defrosting system of a vehicle may lead to potential overheating of the windshield and, subsequently, may lead to issues such as delamination of the layers of the windshield, cracking, etc.

Therefore, more efficient systems for defogging/defrosting vehicle windshields are needed, particularly within electric vehicles.

### SUMMARY

Embodiments of the disclosed heated windshield control assembly for use in a vehicle having a power source may include at least one transparent panel having an inner surface and an outer surface, and a defroster assembly including a conductive medium that is disposed adjacent the inner surface of at least one transparent panel of the at least one transparent panel. A control assembly is operably connected to both the conductive medium and the power source, and the control assembly is configured to control a duty cycle that drives the conductive medium to heat the glass panel assembly.

Also disclosed herein, in some embodiments, is a defroster assembly provided for use with a glass panel assembly of a vehicle having a power source. The defroster assembly preferably includes a conductive medium that is disposed adjacent an inner surface of the glass panel assembly of the vehicle, and a control assembly that is operably connected to both the conductive medium and the power source. The control assembly is configured to control a duty cycle that drives the conductive medium to heat the glass panel assembly.

Additional advantages of the invention will be set forth in part in the description that follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION OF THE DRAWINGS

These and other features of the preferred embodiments of the invention will become more apparent in the detailed description in which reference is made to the appended drawings wherein:

FIG. 1 is a schematic representation of a vehicle that can include a heated windshield control assembly in accordance with an embodiment of the disclosure;

FIG. 2 is a schematic diagram of the heated windshield control assembly of the vehicle shown in FIG. 1;

FIG. 3 is a graphical representation of a control function of the heated windshield control assembly shown in FIG. 2;

FIG. 4 is an alternate graphical representation of the control function graph shown in FIG. 3; and

FIG. 5 is a schematic diagram of the various parameters that can be measured and derived by the disclosed systems and methods.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used throughout, the singular forms “a,” “an,” and “the” include plural referents unless the context clearly dictates otherwise. Thus, for example, unless the context dictates otherwise, reference to “a sensor” provides disclosure of embodiments in which only a single such sensor is provided, as well as embodiments in which a plurality of such sensors are provided.

All technical and scientific terms used herein have the same meaning as commonly understood to one of ordinary skill in the art to which this invention belongs unless clearly indicated otherwise.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of.” For example, “at least one of A, B and C” explicitly includes only A, only B, only C, and combinations of each.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedents “about,” “substantially,” or “generally,” it is contemplated that values within up to 15%, up to 10%, up to 5%, or up to 1% (above or below) of the particularly stated value can be included within the scope of those aspects. In other aspects, when angular values are approximated by use of the antecedents “about,” “substantially,” or “generally,” it is contemplated that angular values within up to 15 degrees, up to 10 degrees, up to 5 degrees, or up to one degree (above or below) of the particularly stated angular value can be included within the scope of those aspects.

The word “or” as used herein means any one member of a particular list and, unless context dictates otherwise, in alternative aspects, can also include any combination of members of that list.

In the following description and claims, wherever the word “comprise” or “include” is used, it is understood that the words “comprise” and “include” can optionally be replaced with the words “consists essentially of” or “consists of” to form another embodiment.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the apparatus, system, and associated methods of using the apparatus can be implemented and used without employing these specific details. Indeed, the apparatus, system, and associated methods can be placed into practice by modifying the illustrated apparatus, system, and associated methods and can be used in conjunction with any other apparatus and techniques conventionally used in the industry.

As further disclosed below, this disclosure relates to systems and methods for providing energy savings with the introduction of closed-loop control for vehicle defrost functions. For closed loop control of defrost functions, there are inherent challenges in placing a sensor for temperature feedback on the outside surface of the windshield due to, among other things, harsh environmental conditions. In order to address these issues, the disclosed systems and methods determine the temperature of the defrost heating element as an input to a model which determines the outside glass temperature without the use of an exterior glass temperature sensor. Other inputs to the model may include one or more of inside glass temperature, cabin temperature, outside temperature, heating element temperature, vehicle speed, etc. As further disclosed herein, this method of measuring the heating element temperature works due to the fact that the resistance of the resistive element increases as its temperature increases, thereby providing a thermodynamic model for the glass panel assembly that allows for determination of the outside glass temperature without the use of a sensor at the exterior surface of the glass.

In exemplary aspects, the disclosed systems and methods can defrost a windshield or other glass panel assembly while minimizing conditioning of glass of the windshield to thereby maximize energy efficiency. Optionally, in some aspects, an exterior glass temperature can be kept at just above the freezing point (e.g., at or above 1 degree Celsius or at or above 2 degrees Celsius). Also disclosed are suitable closed-loop feedback mechanisms for comparing a current status of the resistive element of the windshield to a target setpoint that is associated with a desired outside glass temperature. Based on this feedback, efficient closed-loop control of windshield defrosting can be provided.

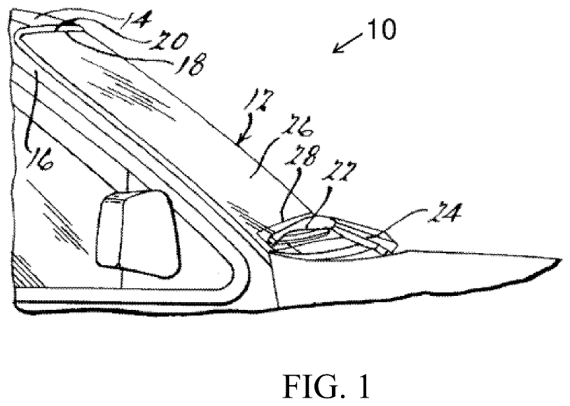

Referring now to the Figures, FIG. 1 schematically illustrates a vehicle 10 that can include a defogging/defrosting control system for a windshield or other glass panel assembly in accordance with an embodiment of the present disclosure. In exemplary aspects, the vehicle 10 can comprise a glass panel assembly 12 (e.g., windshield) disposed within a front opening 18 of a vehicle body 16. The glass panel assembly 12 (e.g., windshield) can be secured within the front opening 18 by a seal 20 or other suitable means. The vehicle 10 also includes at least one wiper 22 (optionally, a pair of wipers) pivotally mounted to the vehicle body 16 by suitable means such as a pivotal wiper arm 24. The wipers 22 rest against an outer or first surface 26 of the glass panel assembly 12 (e.g., windshield) in a wiper rest area 28 at a bottom thereof. Although generally described herein as a windshield, it is contemplated that the glass panel assembly 12 can comprise any arrangement of glass panel(s), such as for example and without limitation, a quarter glass panel as is known in the art.

Optionally, in some exemplary aspects, the vehicle 10 can be a delivery vehicle, a van, a truck, a work truck, a freight truck, a platform truck, a dump truck, construction equipment, or off-highway vehicle. However, it is contemplated that the disclosed windshield control assemblies can be included in any passenger vehicle having a windshield or other glass panel assembly. In exemplary aspects, the vehicle can be an electric vehicle having an electric power source.

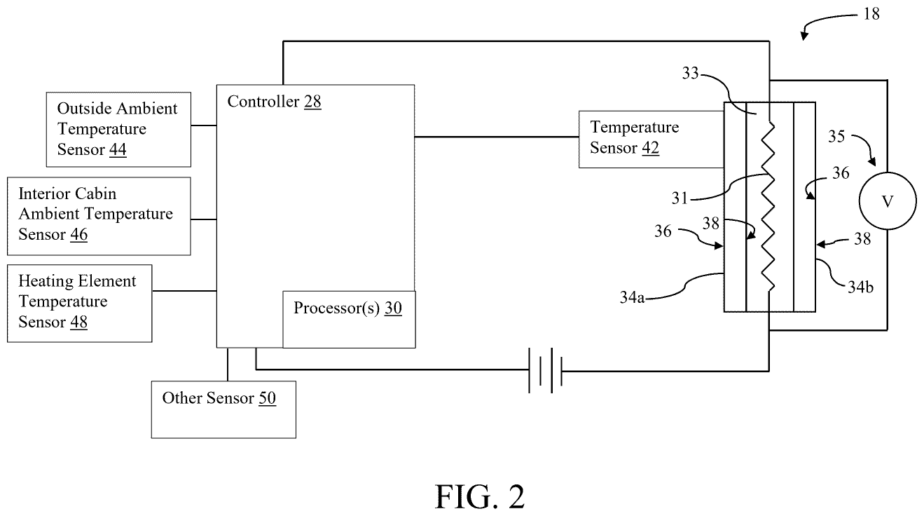

Referring additionally to FIG. 2, an example defogging/defrosting control system 100 for the glass panel assembly 12 (e.g., windshield) of the vehicle 10 may include a controller 28 and preferably one or more processors 30 in communication with one or more sensors as further disclosed herein. In exemplary aspects, the glass panel assembly 12 (e.g., windshield) may comprise at least one transparent panel (optionally, a plurality of transparent panels coupled together by an adhesive layer). The glass panel assembly 12 (e.g., windshield) can further comprise a conductive medium or material (e.g., a wire or film or resistive heating element as further disclosed herein). Optionally, the conductive medium or material can comprise one or more resistive heating elements 31, wherein each resistive heating element includes or consists of conductive traces, films, wires, eGlass (commonly referred to as wiggle wire), or combinations thereof. Optionally, the conductive medium or material (e.g., resistive heating element 31) can be positioned adjacent (e.g., against, or within about 1 mm of) an inner surface 36 of the at least one transparent panel. For example, the at least one panel can comprise an inner panel 34a and an outer panel 34b, each having an inner surface 34 and an outer surface 36. The conductive medium or material can be positioned adjacent the inner surface 36 of the outer transparent panel 34b. In other aspects, the at least one panel can be a single panel. In use, and as further disclosed herein, the controller 28 can control a duty cycle that drives the resistive heating element 31 to heat the glass panel assembly 12 (e.g., windshield). Thus, it is contemplated that the controller 28 can thereby modulate average power over a given duration.

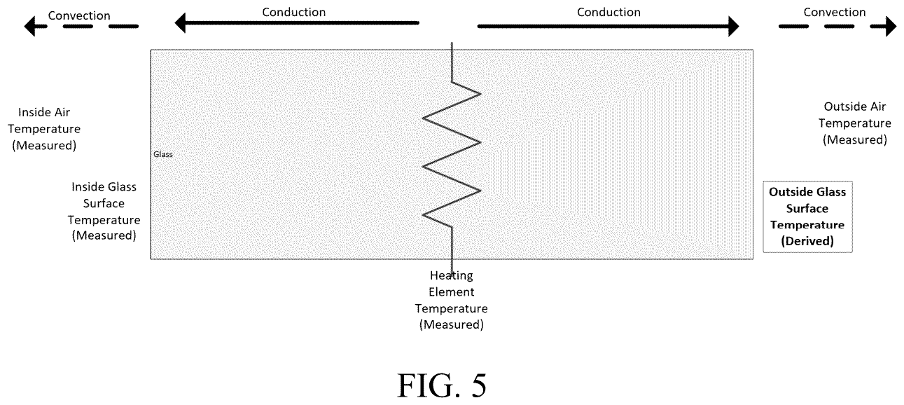

The controller 28 can be in communication with at least one sensor (e.g., a plurality of sensors) by wired or wireless means, wherein each sensor of the at least one sensor (e.g., plurality of sensors) is configured to provide an output to the controller that is indicative of or related to various conditions that may affect the amount of fogging/frosting of the glass panel assembly 12 (e.g., windshield). For example, with reference to FIGS. 2 and 5, the plurality of sensors (e.g., array of sensors) may include one or more of an interior glass temperature sensor 42 (for measuring a temperature at the innermost surface of the glass panel assembly 12), an outside ambient (air) temperature sensor 44, an interior cabin ambient (air) temperature sensor 46, a heating element temperature sensor 48, or other sensor 50 (e.g., vehicle speed sensor and/or interior cabin humidity sensor). Additionally, a sensor 35 can be provided to measure a variable that allows the controller 28 to determine the resistance of the resistive heating element(s) 31 that are disposed in contact with the at least one transparent glass panel. For example, the sensor 35 can measure current. Additionally, as another example, voltage (V) drop across the resistive heating elements 31 can be determined by analog voltage measurement or based on an analog input to the controller. Thus, in combination with measurement of current (I) of the circuit, resistance may be determined using the equation R=V/I. In still other aspects, it is contemplated that resistance can be measured directly.

In exemplary aspects, and as shown in FIG. 2, the resistive heating elements 31 can be disposed between inner and outer transparent layers 34a and 34b (e.g., glass layers), respectively, such as in a polymeric-based material layer 33 (which can optionally comprise an adhesive material). Optionally, in these aspects, the glass panel assembly 12 can comprise a single (exactly one) resistive heating element 31 that is bonded between inner and outer transparent layers 34a, 34b.

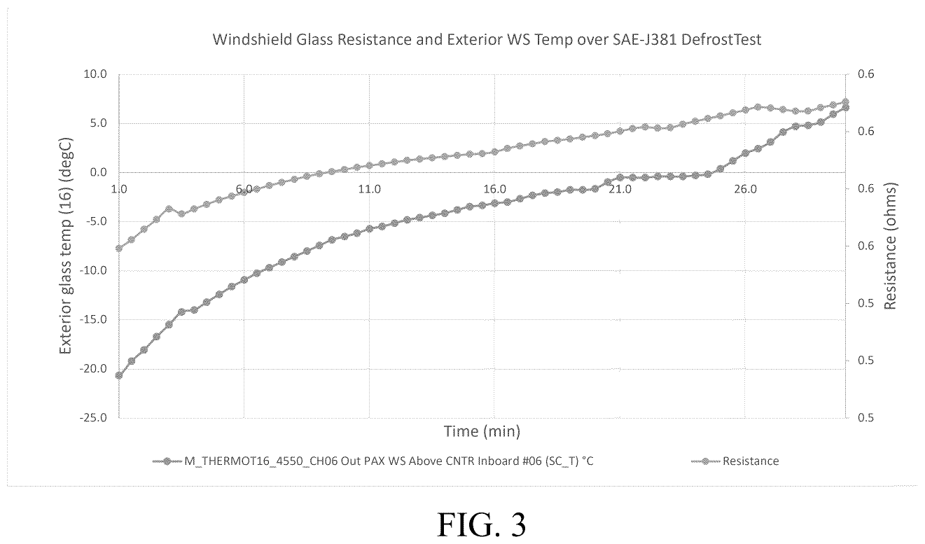

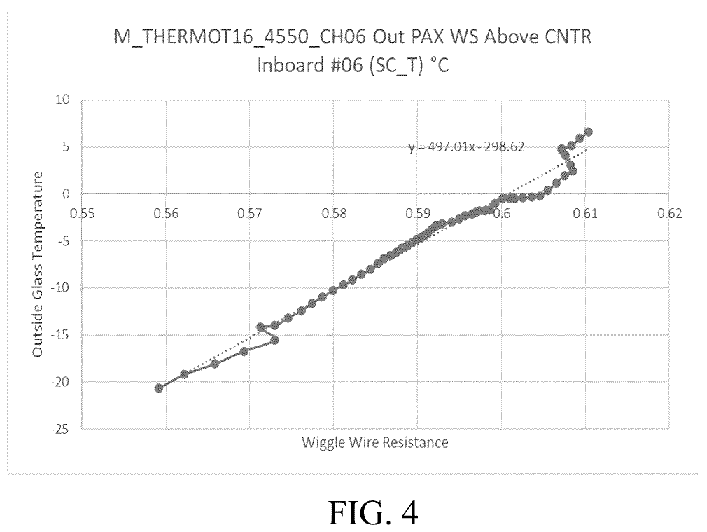

Inputs from the above-mentioned sensors that are provided to the controller 28 are indicative of environmental conditions that may be conducive to windshield fogging and/or frosting. A number of algorithms and/or models may be utilized by the controller 28 to determine the potential for fogging/frosting of the glass panel assembly 12 (e.g., windshield). For example, the controller 28 and processors 30 may be configured to receive inputs from the various sensors and compare those inputs with corresponding threshold values of the measured conditions to determine the potential for fogging/frosting. The controller 28/processors 30 may then utilize stored data from prior tests at varying environmental conditions to determine a desirable duty cycle at which to drive resistive heating element 31 to heat the glass panel assembly (e.g., windshield) to remove or prevent the fog/frost. Importantly, the disclosed systems and methods avoid the need for a sensor disposed on the outside surface of the glass panel assembly. Rather, the resistance of the resistive heating element 31 of the windshield defogging/defrosting system 28, which may be determined as discussed above, is used to determine (e.g., approximate) a corresponding temperature of the resistive heating element, which can be correlated to the temperature that is experienced on the outside of the windshield, as best shown in the graphs of FIGS. 3 and 4.

Specifically, as shown in the graphs of FIGS. 3 and 4, compiled test data shows a direct correlation to an increase in temperature of the resistive heating elements 31 (and temperature on the outside of the glass) and an increase in resistance of the resistive heating elements 31. As noted, the resistance of the resistive heating elements 31 may be determined by sensors that measure the voltage drop across the resistive heating element 31 for a given current during the defogging/defrosting operation. By compiling and storing data (e.g., heating element resistance and windshield temperature) related to models and/or previously conducted tests (for example, eGlass defrost tests in accordance with the SAE J381 standard) under varying environmental conditions in memory, the controller 28 is able to utilize the measured resistance data from the resistive heating element 31 via a closed feedback loop to determine a duty cycle at which to drive the resistive heating element 31 to heat the windshield 18 to remove the fog and/or frost. For example, FIG. 3 shows eGlass resistance derived from determination of Voltage and Current to the eGlass throughout the test, along with outside windshield temperature (measured by a thermocouple). FIG. 4 shows the same data of FIG. 3 in a different format, with heat element resistance plotted against outside glass temperature.

In one exemplary implementation, the disclosed systems and methods can make use of a hysteresis-based control system. In this example, it is contemplated that high and low hysteresis setpoints can be determined based upon a target outside glass temperature. For example, if the target outside glass temperature is established as 2 degrees Celsius, then a switch (e.g., relay) providing current to the resistive heating elements (e.g., eGlass) can be enabled when the determined temperature drops to 1 degree Celsius (or other setpoint below the target outside temperature), and the switch (e.g., relay) can be disabled when the determined temperature rises to 3 degrees Celsius (or other setpoint above the target outside temperature).

In another exemplary implementation, the disclosed systems and methods can make use of a proportional-integral (PI) or proportional-integral-derivative (PID) control system. In this example, it is contemplated that the resistive heating element can be actuated at a very low frequency duty cycle, with the duty cycle varying based on a differential between a target setpoint and a derived/determined outside glass temperature.

Thus, in use, it is contemplated that the disclosed controller 28 and processor can interface with the control circuitry of the vehicle 10 to provide a more efficient system for managing the usage of power by the defrost/deicing system of the vehicle. Rather than providing consistent power delivery upon activation of a defrost cycle by a vehicle controller (e.g., in response to an input provided by the driver) and continuing such power delivery until the defrost function is inactivated, the disclosed systems and methods provide a closed loop mechanism for deriving outside glass temperature based on resistance of the heating elements within the glass panel assembly (e.g., windshield) and then, based on the derived outside glass temperature and pre-determined temperature setpoints, controlling the duty cycle at which the heating element is driven to heat the glass panel assembly.

Although generally disclosed herein as a glass panel assembly, it is contemplated that the disclosed heating and control systems and methods can be applicable to other transparent materials (e.g., plastic or hybrid materials) that can function as windows or windshields of vehicles. Further, embodiments disclosed herein can be used in windows other than windshields, such as rear windows of vehicles.

Although the foregoing invention has been described in some detail by way of illustration and example for purposes of clarity of understanding, certain changes and modifications may be practiced within the scope of the appended claims.

What is claimed is:

1. A glass panel assembly for use in a vehicle having a power source, the glass panel assembly comprising:
at least one transparent panel, each transparent panel of the at least one transparent panel having an inner surface and an outer surface; and
a defroster assembly comprising:
a conductive medium that is disposed adjacent the inner surface of a first panel of at least one transparent panel of the at least one transparent panel; and
a controller that is operably connected to both the conductive medium and the power source,
wherein the controller is configured to determine the resistance of the conductive medium, and wherein, based on the determined resistance of the conductive medium, the controller is further configured to determine a corresponding temperature of the outer surface of the at least one transparent panel, and
wherein, based on the determined corresponding temperature of the outer surface of the at least one transparent panel, the controller is configured to control a duty cycle that drives the conductive medium to heat the at least one transparent panel.

2. The glass panel assembly of claim 1, wherein the conductive medium comprises at least one wire.

3. The glass panel assembly of claim 2, wherein the first panel is an outer panel, wherein the at least one transparent panel further comprises an inner transparent panel, wherein the at least one wire is disposed between the first and the second transparent panels.

4. The glass panel assembly of claim 1, wherein the defroster assembly does not include a sensor for directly measuring temperature of an exterior surface of the at least one transparent panel.

5. The glass panel assembly of claim 1, wherein the controller is configured to compare the determined corresponding temperature of the outer surface of the at least one transparent panel to an optimal exterior glass temperature, and wherein, based on said comparison, the controller is configured to modify the duty cycle that drives the conductive medium to heat the at least one transparent panel.

6. The glass panel assembly of claim 5, wherein the optimal exterior glass temperature is at least 1 degree Celsius.

7. The glass panel assembly of claim 6, wherein the optimal exterior glass temperature is 2 degrees Celsius.

8. The glass panel assembly of claim 5, wherein the controller is configured to effect delivery of current to the conductive medium when the determined corresponding temperature of the outer surface of the at least one transparent panel is below a threshold temperature that is below the optimal exterior glass temperature.

9. The glass panel assembly of claim 5, wherein the controller is configured to prevent or restrict delivery of current to the conductive medium when the determined corresponding temperature of the outer surface of the at least one transparent panel exceeds a threshold temperature above the optimal exterior glass temperature.

10. A vehicle comprising the glass panel assembly as in claim 1.

11. The vehicle of claim 10, wherein the glass panel assembly is a windshield.

12. A method for providing closed-loop control of heating of a glass panel assembly, the glass panel assembly comprising:
at least one transparent panel having an inner surface and an outer surface; and
a defroster assembly comprising:
a conductive medium that is disposed adjacent the inner surface of at least one transparent panel of the at least one transparent panel,
wherein the method comprises:
determining the resistance of the conductive medium;
determining, based on the determined resistance of the conductive medium,
a corresponding temperature of the outer surface of the at least one transparent panel; and
controlling, based on the determined corresponding temperature of the outer surface of the at least one transparent panel, a duty cycle at which power from the power source is provided to the conductive medium of the at least one transparent panel.

13. The method of claim 12, wherein the first panel is an outer panel, wherein the at least one transparent panel further comprises an inner transparent panel, wherein the at least one wire is disposed between the first and the second transparent panels.

14. The method of claim 12, wherein the method does not include receiving a measurement from a sensor that directly measures temperature of an exterior surface of the at least one transparent panel.

15. The method of claim 12, further comprising:
comparing the determined corresponding temperature of the outer surface of the at least one transparent panel to an optimal exterior glass temperature, and
modifying the duty cycle that drives the conductive medium to heat the at least one transparent panel based on said comparison.

16. The method of claim 15, wherein the optimal exterior glass temperature is at least 1 degree Celsius.

17. The method of claim 16, wherein the optimal exterior glass temperature is 2 degrees Celsius.

18. The method of claim 15, further comprising effecting delivery of current to the conductive medium when the determined corresponding temperature of the outer surface of the at least one transparent panel is below a threshold temperature that is below the optimal exterior glass temperature.

19. The method of claim 15, further comprising preventing or restricting delivery of current to the conductive medium when the determined corresponding temperature of the outer surface of the at least one transparent panel exceeds a threshold temperature above the optimal exterior glass temperature.
